(19) United States
(12) Patent Application Publication
(10) Pub. No.: US 2024/0294676 A1
(43) Pub. Date: Sep. 5, 2024

(54) HYDROGENATED POLYETHER-MODIFIED AMINO-FUNCTIONAL POLYBUTADIENES AND PROCESSES FOR PREPARATION THEREOF

(71) Applicant: Evonik Operations GmbH, Essen (DE)

(72) Inventors: Matthias Lobert, Essen (DE); Frank Schubert, Neukirchen-Vluyn (DE); Michael Urban, Essen (DE); Sarah Otto, Essen (DE); Frauke Henning, Essen (DE)

(73) Assignee: Evonik Operations GmbH, Essen (DE)

(21) Appl. No.: 18/564,035

(22) PCT Filed: May 16, 2022
(86) PCT No.: PCT/EP2022/063156

§ 371 Date: Nov. 24, 2023

(30) Foreign Application Priority Data
May 27, 2021 (EP) 21176124.2

(51) Int. Cl. C08F 8/32; C08F 8/08; C08F 236/06

(52) U.S. Cl. CPC C08F 8/32; C08F 8/08; C08F 236/06

(57) ABSTRACT

A process for preparing hydrogenated polyether-modified amino-functional polybutadienes includes: reacting at least one polybutadiene with at least one epoxidizing reagent to give at least one epoxy-functional polybutadiene; reacting the at least one epoxy-functional polybutadiene with at least one amino-functional compound to give at least one hydroxy- and amino-functional polybutadiene; reacting the at least one hydroxy- and amino-functional polybutadiene with at least one epoxy-functional compound to give at least one polyether-modified amino-functional polybutadiene; and hydrogenating the at least one polyether-modified amino-functional polybutadiene to give at least one hydrogenated polyether-modified amino-functional polybutadiene.

The invention relates to a process for preparing hydrogenated polyether-modified amino-functional polybutadienes and to hydrogenated polyether-modified amino-functional polybutadienes preparable by this process.

Polybutadienes having pendant polyether radicals are known and are prepared according to the prior art, for example, by a reaction of reactive, functionalized polybutadienes with polyethers. For instance, Q. Gao et al. in Macromolecular Chemistry and Physics (2013), 214(15). 1677-1687 describe amphiphilic polymer comb structures that are prepared by grafting polyethylene glycol onto a main polybutadiene chain. According to JP 2011038003, polybutadienes functionalized with maleic anhydride units are reacted with amino-terminated polyethers. The result is maleinized polybutadienes having polyether radicals in comb positions, attached via an amide or imide group. In a similar process, according to J. Wang, Journal of Applied Polymer Science (2013), 128(4), 2408-2413, polyethylene glycols are added onto polybutadienes having a high proportion of 1,2-butadiene monomer units to form an ester linkage. High molecular weight graft polymers having a comb structure are obtained by the process disclosed in JP 2002105209 by an addition of epoxidized polybutadienes with OH-functional polyethers. H. Decher et al., according to Polymer International (1995), 38(3), 219-225, use the addition of isocyanate-terminated polyethylene glycols onto hydroxy-functional polybutadienes.

Also known are processes for preparing polyether-modified polybutadienes in which hydroxy-functional polybutadienes are reacted with epoxy compounds. For example, the prior art discloses the alkoxylation of OH-terminated polybutadienes.

U.S. Pat. No. 4,994,621 A describes, for example, the alkoxylation of hydroxy-terminated polybutadienes with ethylene oxide and propylene oxide in the presence of tetramethylammonium hydroxide. The use of hydroxy-terminated polybutadienes in alkoxylation leads exclusively to polyether-polybutadiene-polyether triblock structures. According to EP 2003156 A1, this block structure is responsible for the poor miscibility with other reaction components in the preparation of polyurethanes.

As well as the alkoxylation of hydroxy-terminated polybutadienes, the alkoxylation of pendantly hydroxy-functional polybutadienes is also known. For instance, Q. Gao et al. in Macromolecular Chemistry and Physics (2013), 214(15), 1677-1687 describe the preparation of a pendantly polyether-modified polybutadiene by alkoxylation of a pendantly hydroxy-functional polybutadiene with ethylene oxide. The pendantly hydroxy-functional polybutadiene used here is prepared first by epoxidation of a polybutadiene, followed by reaction of the epoxidized polybutadiene with a lithium-polybutadiene compound, and finally protonation of the reaction product with methanolic HCl. This process leads to a polybutadiene having both pendant polyether radicals, and also pendant polybutadiene radicals.

The chemical modification of polybutadiene with the aid of epoxidation and subsequent epoxide ring-opening by reaction with amines is known. JP 63288295 discloses the reaction of epoxy-functional polybutadienes with dimethylamine and the subsequent protonation of the amine functions with acetic acid. The method according to JP 57205596 includes, in addition to the epoxide ring-opening with dimethylamine, the further quaternization of the amine functions with epichlorohydrin. A method for epoxide ring-opening of hydrogenated polybutadienes with amines is disclosed in DE 2554093. DE 2943879. DE 2732736 and JP 49055733 describe the addition of diethanolamine. JP 48051989 likewise describes the addition of diethanolamine, followed by a crosslinking reaction in the presence of dibenzoyl peroxide. JP 53117030, DE 2734413 and DE 2943879 describe the addition of ethanolamine, JP 05117556 the reaction with diisopropanolamine, EP 0351135. EP 0274389 and DE 3305964 the reaction of the epoxy groups with dimethylamine. DE 296286 discloses the addition of primary and secondary amines having 4 to 20 carbon atoms onto epoxidized polybutadienes in polar solvents. Further alkoxylation of the amino-functional polybutadienes is not disclosed in any of these documents.

Polybutadienes and modified polybutadienes are in many cases used as reactive component or formulation constituent in order, for example, to render polymers hydrophobic or to flexibilize them and improve mechanical properties. At present, however, there are frequently limits to the possible uses of polyether-modified polybutadienes as a result of the restriction to a small number of available triblock structures. There has therefore been no way of varying to a large degree the chemical makeup of the polyether-modified polybutadienes. Moreover, there is no simple preparation process for such polymers.

The hydrogenation of unsaturated compounds in general and in particular unsaturated polymers such as polybutadiene polymers or polybutadiene-isoprene copolymers are known in principle and may be carried out both with heterogeneous and homogeneous catalysts.

Hydrogenation catalysts familiar to those skilled in the art are, for example, of the nickel type, such as Raney nickel, or also palladium. Whereas nickel-catalyzed reactions are usually characterized by a low reaction rate, a significantly faster reaction occurs with palladium catalysis.

For instance, DE 2459115 A1 describes the hydrogenation of polybutadienes in the presence of supported ruthenium catalysts and DE 1248301 B describes the use of cobalt, nickel, manganese, molybdenum and tungsten compounds, which are applied to inert support materials by aluminium reducing agents, as efficient heterogeneous hydrogenation catalysts. DE 2457646 A1 also describes an efficient hydrogenation catalyst based on cobalt, prepared from Co(II) chloride by a reducing reaction with lithium, sodium or potassium salts of a lactam.

Furthermore, DE 2637767 A1 also describes triphenylphosphine salts of rhodium (Wilkinson's catalyst), iridium and ruthenium as selective catalysts for the hydrogenation of the 1,2-vinyl moieties of the polybutadiene polymer. In addition, Wilkinson's catalyst is also used advantageously as a polymer-bound catalyst in EP 0279766 A1.

EP 0545844 A1 describes a titanocene catalyst as homogeneous catalyst, which is converted into its active form by in situ reduction with organometallic compounds.

However, no hydrogenated polyether-modified polybutadienes and accordingly no processes for preparation thereof are known from the prior art.

The object of the present invention, therefore, was to provide hydrogenated polyether-modified polybutadienes.

A particular problem addressed was that of providing a process for preparing preferably linear hydrogenated polybutadienes modified with polyether radicals in comb (pendant, lateral) positions via an amino group.

It has now been found that, surprisingly, this problem is solved by a process for preparing hydrogenated polyether-modified amino-functional polybutadienes that comprises the following steps:
a) reacting at least one polybutadiene (A) with at least one epoxidizing reagent (B) to give at least one epoxy-functional polybutadiene (C);
b) reacting the at least one epoxy-functional polybutadiene (C) with at least one amino-functional compound (D) to give at least one hydroxy- and amino-functional polybutadiene (E);
c) reacting the at least one hydroxy- and amino-functional polybutadiene (E) with at least one epoxy-functional compound (F) to give at least one polyether-modified amino-functional polybutadiene (G);
d) hydrogenating the at least one polyether-modified amino-functional polybutadiene (G) to give at least one hydrogenated polyether-modified amino-functional polybutadiene (H).

Further subject matters of the invention and advantageous embodiments thereof can be found in the claims, the examples and the description.

The subject matter of the invention is described by way of example below but without any intention that the invention be restricted to these illustrative embodiments. Where ranges, general formulae or classes of compounds are specified below, these are intended to encompass not only the corresponding ranges or groups of compounds that are explicitly mentioned but also all subranges and subgroups of compounds that can be obtained by removing individual values (ranges) or compounds. Where documents are cited in the context of the present description, the entire content thereof is intended to be part of the disclosure content of the present invention.

Where average values are stated hereinbelow, these are, unless otherwise stated, numerical averages. Where measured values, parameters or material properties determined by measurement are stated hereinbelow, these are, unless otherwise stated, measured values, parameters or material properties measured at 25° C. and preferably at a pressure of 101 325 Pa (standard pressure).

In the context of the present invention, number-average molar mass Mₙ, weight-average molar mass M_{w} and polydispersity (M_{w}/Mₙ) are preferably determined by gel-permeation chromatography (GPC), as described in the examples unless explicitly stated otherwise.

Where numerical ranges in the form “X to Y” are reported hereinafter, where X and Y represent the limits of the numerical range, this is synonymous with the statement “from at least X up to and including Y”, unless stated otherwise. Statements of ranges thus include the range limits X and Y, unless stated otherwise.

The terms “pendant”, “lateral” and “in comb positions” are used synonymously.

Wherever molecules/molecule fragments have one or more stereocentres or can be differentiated into isomers on account of symmetries or can be differentiated into isomers on account of other effects, for example restricted rotation, all possible isomers are included by the present invention.

The formulae below describe compounds or radicals that are constructed from optionally repeat units (repeating units), for example repeating fragments, blocks or monomer units, and may have a molar mass distribution. The frequency of the units is specified by indices unless explicitly stated otherwise. The indices used in the formulae should be regarded as statistical averages (numerical averages) unless explicitly stated otherwise. The indices used and also the value ranges of the reported indices should thus be regarded as averages of the possible statistical distribution of the structures that are actually present and/or mixtures thereof, unless explicitly stated otherwise. The various fragments or units of the compounds described in the formulae below may be distributed statistically. Statistical distributions have a blockwise structure with any number of blocks and any sequence or are subject to a randomized distribution; they may also have an alternating structure or else form a gradient along the chain, where one is present: in particular they can also give rise to any mixed forms in which groups having different distributions may optionally follow one another. The formulae below include all permutations of units. Where compounds such as polybutadienes (A), epoxy-functional polybutadienes (C), hydroxy- and amino-functional polybutadienes (E), polyether-modified amino-functional polybutadienes (G) or hydrogenated polyether-modified amino-functional polybutadienes (H) that can have multiple instances of different units are described in the context of the present invention, these may thus occur in these compounds either in an unordered manner, for example in statistical distribution, or in an ordered manner. The figures for the number or relative frequency of units in such compounds should be regarded as an average (numerical average) over all the corresponding compounds. Specific embodiments may lead to restrictions on statistical distributions as a result of the embodiment. For all regions unaffected by such restriction, the statistical distribution is unchanged.

The invention thus firstly provides a process for preparing one or more hydrogenated polyether-modified amino-functional polybutadienes, comprising the steps of:
a) reacting at least one polybutadiene (A) with at least one epoxidizing reagent (B) to give at least one epoxy-functional polybutadiene (C);
b) reacting the at least one epoxy-functional polybutadiene (C) with at least one amino-functional compound (D) to give at least one hydroxy- and amino-functional polybutadiene (E);
c) reacting the at least one hydroxy- and amino-functional polybutadiene (E) with at least one epoxy-functional compound (F) to give at least one polyether-modified amino-functional polybutadiene (G);
d) hydrogenating the at least one polyether-modified amino-functional polybutadiene (G) to give at least one hydrogenated amino-functional polyether-modified polybutadiene (H).

It is preferable that the process of the invention additionally comprises precisely one of the following two optional steps cc) and dd):
cc) reacting at least one polyether-modified amino-functional polybutadiene (G) without end-capped polyether radicals with at least one end-capping reagent (I) to give at least one polyether-modified amino-functional polybutadiene (G) comprising end-capped polyether radicals;
dd) reacting at least one hydrogenated amino-functional polyether-modified polybutadiene (H) without end-capped polyether radicals with at least one end-capping reagent (I) to give at least one hydrogenated polyether-modified amino-functional polybutadiene (H) comprising end-capped polyether radicals.

It is therefore preferable that the process of the invention comprises either step cc) or step dd) or neither of these two steps.

The polyether-modified amino-functional polybutadiene (G) without end-capped polyether radicals is also referred to below as (G1). The polyether-modified amino-functional polybutadiene (G) comprising end-capped polyether radicals is also referred to below as (G2). Both (G1) and (G2) are polyether-modified amino-functional polybutadienes (G).

The hydrogenated polyether-modified amino-functional polybutadiene (H) without end-capped polyether radicals is also referred to below as (H1). The hydrogenated polyether-modified amino-functional polybutadiene (H) comprising end-capped polyether radicals is also referred to below as (H2). Both (H1) and (H2) are hydrogenated polyether-modified amino-functional polybutadienes (H).

It is preferable that the process of the invention additionally includes at least one of the following steps:
e) colour lightening of the at least one hydrogenated polyether-modified amino-functional polybutadiene (H);
f) converting at least some amino groups of the at least one hydrogenated polyether-modified amino-functional polybutadiene (H) to quaternary ammonium groups by means of an acid and/or a quaternizing reagent.

The steps a), b), c), cc) d), dd), e) and f) are carried out in the sequence specified, i.e. in the sequence a), b), c), cc) d), dd), e) and f), in which one or more of the steps cc), dd), e) and f) are optional and may be omitted, in which either the step cc) or the step dd) or neither of these two steps are included. The steps may follow each other directly. The process may however also have further upstream steps, intermediate steps or downstream steps, such as purification of the reactants, the intermediates and/or the end products.

The polybutadienes (E) prepared from the epoxy-functional polybutadienes (C) by epoxide ring-opening with amines are characterized in that they have both pendant amino groups and hydroxyl groups. Depending on the reaction conditions in step c), the addition of the epoxy-functional compounds (F) occurs on the amino groups, on the hydroxyl groups or preferably on both reactive groups.

By means of the process according to the invention, it will be possible for the first time to obtain hydrogenated polyether-modified polybutadienes, especially linear hydrogenated polybutadienes having polyether radicals in comb positions. The chain length and monomer sequence in the polyether radical may be varied within wide ranges. The average number of polyether radicals bonded to the polybutadiene is adjustable in a controlled manner via the degree of epoxidation and the functionalization with amino and hydroxyl groups and opens up a great structural variety in the hydrogenated polyether-modified amino-functional polybutadienes (H).

The hydrogenated amino-functional polybutadienes having polyether radicals in comb positions that are obtainable in accordance with the invention are preferably essentially free of residual epoxy groups. The process product according to the invention preferably contains essentially no free polyether components. Preferably, essentially the polyethers are chemically attached to the (hydrogenated) polybutadiene via a nitrogen atom and/or via an oxygen atom.

It is preferable in this case, during the process according to the invention, to stabilize the reactants, intermediates and products using stabilizers or antioxidants in order to avoid unwanted polymerization reactions of the double bonds. Suitable for this purpose are, for example, the sterically hindered phenols known to those skilled in the art, commercially available, for example, as Anox® 20, Irganox® 1010 (BASF). Irganox® 1076 (BASF) and Irganox® 1135 (BASF).

It is further preferable to conduct one or more or all process steps under an inert atmosphere, for example under nitrogen. It is also preferable that the reactant (A), as well as the intermediates (C), (E) and (G), and also the end product (H), if they are not completely but only partially hydrogenated, to be stored as far as possible with exclusion of air.

### Step a)

In step a) of the process according to the invention, at least one polybutadiene (A) is reacted with at least one epoxidizing reagent (B) to give at least one epoxy-functional polybutadiene (C).

In this reaction double bonds of the polybutadiene (A) are converted to epoxy groups. Various methods of epoxidizing polybutadienes, for example with percarboxylic acids and hydrogen peroxide, are known to the person skilled in the art and are disclosed, for example, in CN 101538338, JP 2004346310, DD 253627 and WO 2016/142249 A1. Performic acid is particularly suitable for preparation of the epoxy-functional polybutadienes (C) having a high proportion of 1,4 units and can also be formed in situ from formic acid in the presence of hydrogen peroxide. The epoxidation preferably takes place in a solvent such as toluene or chloroform, which is removed by distillation after the reaction and after the washing-out of any peroxide residues.

The polybutadienes (A) are polymers of buta-1,3-diene. The polymerization of the buta-1,3-diene monomers is effected essentially with 1,4 and/or 1,2 linkage. 1,4 linkage leads to what are called 1,4-trans units and/or 1,4-cis units, which are also referred to collectively as 1,4 units. 1,2 linkage leads to what are called 1,2 units. The 1,2 units bear a vinyl group and are also referred to as vinylic 1,2 units. In the context of the present invention, the 1,2 units are also referred to as “(X)”, the 1,4-trans units as “(Y)”, and the 1,4-cis units as “(Z)”:

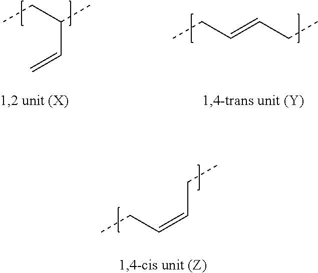

The double bonds present in the units are referred to analogously as 1,4-trans double bonds, 1,4-cis double bonds, or as 1,2 double bonds or 1,2 vinyl double bonds. The 1,4-trans double bonds and 1,4-cis double bonds are also referred to collectively as 1,4 double bonds.

The polybutadienes (A) are thus unmodified polybutadienes. The polybutadienes (A) and their preparation processes are known to the person skilled in the art. Preparation is preferably effected by means of a free-radical, anionic or coordinative chain polymerization.

Free-radical chain polymerization is preferably conducted as an emulsion polymerization. This leads to statistical occurrence of the three units mentioned. In the case of a low reaction temperature (about 5° C.), there is a fall in the proportion of vinyl groups. Initiation is preferably effected with potassium peroxodisulfate and iron salts, or else with hydrogen peroxide.

In anionic chain polymerization, the chain polymerization is preferably initiated with butyllithium. The polybutadiene (A) thus obtained contains about 40%1,4-cis units and 50%1,4-trans units.

In the case of coordinative chain polymerization, preference is given to using Ziegler-Natta catalysts, especially stereospecific Ziegler-Natta catalysts, that lead to a polybutadiene (A) having a high proportion of 1,4-cis units.

The polymerization of 1,3-butadiene, due to side reactions or further reactions, for example a further reaction of the double bonds of the resulting 1,2 and 1,4 units of the polybutadiene, may also result in branched polybutadienes (A). However, the polybutadienes (A) used in accordance with the invention are preferably linear, i.e. unbranched, polybutadienes. It is also possible that the polybutadienes include small proportions of units other than 1.2 units. 1,4-trans units or 1,4-cis units. However, it is preferable that the proportion by mass of the sum total of 1,2 units, 1,4-trans units and 1,4-cis units is at least 80%, preferably at least 90%, especially at least 99%, based on the total mass of the at least one polybutadiene (A), i.e. based on the total mass of all polybutadienes (A) used.

For the process according to the invention, preference is given to using those polybutadienes (A) that have 0% to 80%1,2 units and 20% to 100%1,4 units, more preferably 0% to 30%1,2 units and 70% to 100% 1,4 units, still more preferably 0% to 10%1,2 units and 90% to 100%1,4 units, and most preferably 0% to 5%1,2 units and 95% to 100%1,4 units, based on the sum total of 1,2 units and 1,4 units.

It is therefore preferable that, of the double bonds of all the polybutadienes (A) used, 0% to 80% are 1,2 vinyl double bonds and 20% to 100% are 1,4 double bonds, more preferably 0% to 30% are 1,2 vinyl double bonds and 70% to 100% are 1,4 double bonds, even more preferably 0% to 10% are 1,2 vinyl double bonds and 90% to 100% are 1,4 double bonds, most preferably 0% to 5% are 1,2 vinyl double bonds and 95% to 100% are 1,4 double bonds.

For the inventive preparation of the products, accordingly, preference is given to using polybutadienes (A) of the formula (1)

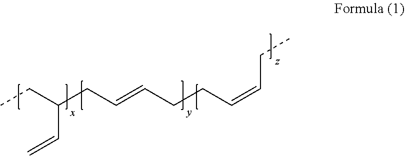

having a content of 0% to 80%1,2 vinyl double bonds (index x) and 20% to 100%1,4 double bonds, more preferably 0% to 30%1,2 vinyl double bonds and 70% to 100%1,4 double bonds, even more preferably 0% to 10%1,2 vinyl double bonds and 90% to 100%1,4 double bonds, most preferably having 0% to 5% 1,2 vinyl double bonds and 95% to 100%1.4 double bonds. The ratio of 1,4-trans double bonds (index y) and 1,4-cis double bonds (index z) is freely variable.

The indices x, y and z give the number of the respective butadiene unit in the polybutadiene (A). The indices are average values (numerical averages) over the entirety of all polybutadiene polymers of the at least one polybutadiene (A).

The average molar mass and polydispersity of the polybutadienes (A) of formula (1) used is freely variable.

It is preferable that the number-average molar mass Mₙ of the at least one polybutadiene (A) is from 200 g/mol to 20 000 g/mol, more preferably from 500 g/mol to 10 000 g/mol, most preferably from 700 g/mol to 5000 g/mol.

Alternatively, it is preferable that the number-average molar mass Mₙ of the at least one polybutadiene (A) is from 2100 g/mol to 20 000 g/mol, more preferably from 2200 g/mol to 10 000 g/mol, most preferably from 2300 g/mol to 5000 g/mol.

It is further preferable that the at least one polybutadiene (A) has a numerical average of 5 to 360, more preferably 10 to 180, most preferably 15 to 90, units selected from the group consisting of 1,2 units, 1,4-cis units and 1,4-trans units.

Alternatively, it is preferable that the at least one polybutadiene (A) has a numerical average of 35 to 360, more preferably 40 to 180, most preferably 45 to 90, units selected from the group consisting of 1,2 units, 1,4-cis units and 1,4-trans units.

It is further preferable that the viscosity of the polybutadienes (A) used is 50 to 50 000 mPas, more preferably 100 to 10 000 mPas, most preferably 500 to 5000 mPas (determined to DIN EN ISO 3219:1994-10).

Polybutadienes used with most preference are the commercially available Polyvest® 110 and Polyvest® 130 products from Evonik Industries AG/Evonik Operations GmbH, having the following typical indices:
Polyvest® 110: ca. 1%1,2 vinyl double bonds, ca. 24%1,4-trans double bonds, ca. 75%1,4-cis double bonds, number-average molar mass Ma ca. 2600 g/mol, viscosity (20° C.) 700-860 mPas (to DIN EN ISO 3219:1994-10),
Polyvest® 130: ca. 1%1,2 vinyl double bonds, ca. 22%1,4-trans double bonds, ca. 77%1,4-cis double bonds, number-average molar mass Mₙ ca. 4600 g/mol, viscosity (20° C.) 2700-3300 mPas (to DIN EN ISO 3219:1994-10).

Polybutadienes used with most preference are also the Lithene ultra AL and Lithene ActiV 50 products available from Synthomer PLC, having the following typical indices:
Lithene ultra AL: ca. 40%1,2 vinyl double bonds, ca. 60%1,4 double bonds,
Lithene ActiV 50: ca. 70%1,2 vinyl double bonds, ca. 30%1,4 double bonds,

The degree of epoxidation is determined quantitatively, for example, with the aid of 13C NMR spectroscopy or epoxy value titration (determinations of the epoxy equivalent according to DIN EN ISO 3001:1999), and can be adjusted in a controlled and reproducible manner via the process conditions, especially via the amount of hydrogen peroxide used in relation to the amount of double bonds in the initial charge of polybutadiene.

It is preferable in step a) of the process according to the invention that from >0% to <100%, more preferably from >0% to 70%, even more preferably from 1% to 50%, still more preferably from 2% to 40%, even more preferably from 3% to 30% and most preferably from 4% to 20% of all double bonds of the at least one polybutadiene (A) are epoxidized.

Usable epoxidizing reagents (B) are in principle all epoxidizing agents known to the person skilled in the art. It is preferable that the epoxidizing reagent (B) is selected from the group of the peroxycarboxylic acids (percarboxylic acids, peracids), preferably from the group consisting of meta-chloroperbenzoic acid, peroxyacetic acid (peracetic acid) and peroxyformic acid (performic acid), especially peroxyformic acid (performic acid). The peroxycarboxylic acids are preferably formed in situ from the corresponding carboxylic acid and hydrogen peroxide.

It is most preferable that the at least one epoxidizing reagent (B) is or comprises performic acid which is preferably formed in situ from formic acid and hydrogen peroxide.

The epoxidation of the at least one polybutadiene (A) takes place preferentially at the 1.4 double bonds in a statistical distribution over the polybutadiene chain. Epoxidation of the 1,2 double bonds can likewise take place, and likewise takes place in statistical distribution over the polybutadiene chain at these bonds. However, epoxidation of the 1,2 double bonds is less favoured compared to epoxidation of the 1,4 double bonds. The reaction product thus contains epoxy-functional polybutadiene polymers that differ from one another in their degree of epoxidation. All the degrees of epoxidation stated should therefore be regarded as average values.

### Step b)

In step b) of the process according to the invention, the at least one epoxy-functional polybutadiene (C) is reacted with at least one amino-functional compound (D) to give at least one hydroxy- and amino-functional polybutadiene (E).

An addition (addition reaction) of the at least one amino-functional compound (D) onto the at least one epoxy-functional polybutadiene (C) takes place in this reaction. Therefore, the reaction takes place forming one or more covalent bonds between the at least one amino-functional compound (D) and the at least one epoxy-functional polybutadiene (C). The reaction preferably comprises (at least idealizes) a reaction step in which a nucleophilic attack takes place of at least one amino group of the at least one amino-functional compound (D) on at least one epoxy group of the at least one epoxy-functional polybutadiene (C) with ring-opening of this at least one epoxy group.

It is preferable that the at least one amino-functional compound (D) is selected from compounds having at least one primary and/or at least one secondary amino group, since primary and secondary amino groups are particularly easily added onto the epoxy groups of the polybutadiene. In the context of the present invention, ammonia is also included in these amino-functional compounds (D). However, it is preferable that the at least one amino-functional compound (D) is selected from organic compounds having at least one primary and/or at least one secondary amino group. It is even more preferable that the at least one amino-functional compound (D) is selected from organic compounds having 1 to 22 carbon atoms and also at least one primary and/or at least one secondary amino group. It is even more preferable that the at least one amino-functional compound (D) is selected from organic compounds having 1 to 12 carbon atoms and also at least one primary and/or at least one secondary amino group. It is also preferable that the amino-functional compound (D) has precisely one primary or secondary amino group. As a result, undesired crosslinking reactions can be reduced or prevented. It is also preferable that the amino-functional compound (D) is not an aromatic amine, particularly not an aromatic primary amine, since some aromatic primary amines are known to be human carcinogens. In the context of the present invention, an aromatic amine is understood to be those amines in which the nitrogen atom of at least one amino group is bonded to a carbon atom which is in turn part of an aromatic ring system.

It is further preferable that the at least one amino-functional compound (D) is selected from the group consisting of ammonia, alkylamines, cycloalkylamines, dialkylamines, monoalkanolamines and dialkanolamines. The aliphatic radicals bonded to the nitrogen may also bear aromatic radicals or heteroatoms such as nitrogen or oxygen. It is therefore also likewise preferable that the at least one amino-functional compound (D) is selected from the group consisting of diamines, polyamines, polyetheramines and hydroxy-functional aliphatic amines. The at least one amino-functional compound (D) is more preferably selected from the group consisting of alkylamines, cycloalkylamines, dialkylamines, monoalkanolamines, dialkanolamines and trialkanolamines, each having 1 to 22 carbon atoms and having precisely one primary or secondary amino group. The at least one amino-functional compound (D) is even more preferably selected from the group consisting of alkylamines, monoalkanolamines, dialkanolamines and trialkanolamines, each having 1 to 12 carbon atoms and precisely one primary or secondary amino group. The at least one amino-functional compound (D) is most preferably selected from the group consisting of butylamine, isobutylamine, hexylamine, octylamine, 2-ethylhexylamine, decylamine, laurylamine, ethanolamine, isopropanolamine, diethanolamine, diisopropanolamine, N-methylethanolamine, N-methylisopropanolamine, 2-amino-2-methyl-1-propanol, 2-amino-2-ethyl-1,3-propanediol, tris(hydroxymethyl)aminomethane (TRIS, 2-amino-2-(hydroxymethyl)propane-1,3-diol), morpholine, piperidine, cyclohexylamine, N,N-dimethylaminopropylamine (DMAPA) and benzylamine. It is also possible here to use any desired mixtures of these amines. In the context of the present invention, the term “trialkanolamines” are understood to mean only those trialkanolamines bearing primary and/or secondary amino groups, such as tris(hydroxymethyl)aminomethane.

The molar ratio of the NH groups of the at least one amino-functional compound (D) to the epoxy groups of the at least one epoxy-functional polybutadiene (C) may be varied within a wide range. It is however preferable that the at least one amino-functional compound (D) and the at least one epoxy-functional polybutadiene (C) are used in such a molar ratio of NH groups to epoxy groups that as far as possible a quantitative conversion of all epoxy groups is achieved. It is therefore preferable that, in step b), the total number of NH groups in all the amino-functional compounds (D) to the total number of epoxy groups in all the epoxy-functional polybutadienes (C) is from 0.8:1 to 20:1, more preferably from 0.9:1 to 10:1, even more preferably from 1:1 to 5:1, most preferably from 1:1 to 3:1. The excess of compound (D) may be removed, for example by distillation, after the reaction and be reused if required. In this connection it should be noted that an ammonia molecule has exactly three, a primary amino group exactly two and a secondary amino group exactly one NH group.

The epoxide ring-opening with amines may optionally be carried out in a solvent such as ethanol, propanol, isopropanol or THF. Preferably, the solvent is omitted.

Preferably, the reaction is conducted in the presence of at least one catalyst. The catalyst is alternatively homogeneously soluble in the reaction mixture, may be added as an aqueous solution or is heterogeneously distributed therein as a solid.

It is preferable that the catalyst is selected from the group consisting of Lewis acids and Brønsted acids; more preferably from the group consisting of water, phenols, alcohols, carboxylic acids, ammonium compounds, phosphonium compounds and lithium bromide; even more preferably from the group consisting of carboxylic acids, phenols, ammonium compounds, phosphonium compounds and lithium bromide, even more preferably from the group consisting of carboxylic acids, phenol and lithium bromide, most preferably lithium bromide. The catalyst is alternatively homogeneously soluble in the reaction mixture, may be added as an aqueous solution or is heterogeneously distributed therein as a solid.

The type of catalyst and the amount used are selected so as to achieve very rapid and quantitative addition of the at least one amino-functional compound (D) onto the epoxy groups of the at least one epoxy-functional polybutadiene (C). Lithium bromide is preferably used, as a solid or dissolved in water, in a proportion by mass of 0.05% to 15.0%, preferably 0.2% to 10.0%, most preferably 0.5% to 7.0%, based on the mass of the at least one amino-functional compound (D).

The reaction of the at least one epoxy-functional polybutadiene (C) with the at least one amino-functional compound (D), optionally in the presence of a catalyst, is preferably carried out at 50° C. to 250° C., more preferably at 80° C. to 200° C.

The components are stirred for a few hours until the epoxy groups have been converted as fully as possible. The analysis for epoxy groups can be effected alternatively by NMR spectroscopy analysis or by known methods of epoxy value titration (as described in the examples).

The reaction conditions in step b) are preferably chosen such that more than 90% of the epoxy groups generated in step a) are converted under ring-opening. It is especially preferable that no epoxy groups are detectable any longer in the product from step b). i.e. in the at least one hydroxy- and amino-functional polybutadiene (E).

After the reaction, the possible excess amino-functional compounds (D) and optionally solvent, water and the catalyst are preferably removed by distillation and precipitated salts are filtered off as required.

Each epoxy group in an epoxy-functional polybutadiene (C), after ring-opening by an amino-functional compound (D) of the formula A₁-NH-A₂, results in a unit of the formula (2a), (2b) or (2c):

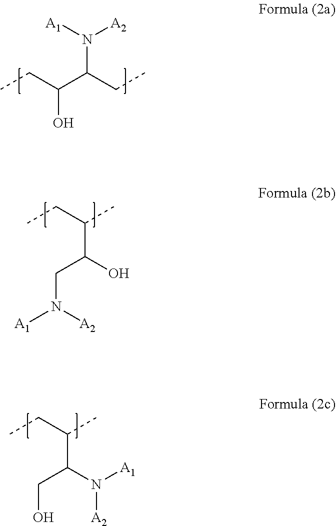

In the formulae (2a), (2b) and (2c), the radicals A₁ and A₂ are preferably each independently organic radicals, which may bear further amine or hydroxyl groups, or hydrogen radicals. The radicals A₁ and A₂ may therefore comprise heteroatoms such as nitrogen and oxygen and may also be bridged to each other via an organic radical, such as in the case of morpholine or piperidine. The amino-functional compound (D) of the formula A₁-NH-A₂ may also be ammonia. In the case of ammonia, both A₁ and A₂ are hydrogen radicals. If, for example, ethanolamine is used as amino-functional compound (D), the radical A₁ in the formulae (2a), (2b), and (2c) is, for example a hydroxyethyl radical and the radical A₂ is then a hydrogen radical, i.e. A₂=H. Each reacted epoxy group results in at least one pendant OH group.

If a primary amine as compound (D) is reacted with an epoxy group of an epoxy-functional polybutadiene (C), a secondary amino group always forms having a reactive hydrogen atom on the nitrogen atom. This secondary amino group can add to a further epoxy group in a subsequent reaction via the NH group and thus link two epoxy-functional polybutadienes (C) to each other. The reaction conditions in step b) are preferably selected such that this linking reaction is largely suppressed.

In the case of the polybutadienes (A) having a predominant proportion of 1,4 units that are preferred in accordance with the invention, those of the formula (2a) are predominant among the units of the formulae (2a), (2b) and (2c).

It is preferable that the at least one hydroxy- and amino-functional polybutadiene (E) has 20% to 100%, more preferably 70% to 100%, even more preferably 90% to 100%, most preferably 95% to 100% units of the formula (2a), based on the total number of all units of the formulae (2a), (2b) and (2c).

It is preferable that the proportion of units of the formulae (2a), (2b) and (2c) taken together is from >0% to <100%, more preferably from >0% to 70%, even more preferably from 1% to 50%, still more preferably from 2% to 40%, still more preferably from 3% to 30% and most preferably from 4% to 20%, based on the total number of all units of the at least one hydroxy- and amino-functional polybutadiene (E).

Accordingly, it is preferable that the degree of amination is from >0% to <100%, more preferably from >0% to 70%, even more preferably from 1% to 50%, still more preferably from 2% to 40%, still more preferably from 3% to 30% and most preferably from 4% to 20%.

On completion of conversion in step b), the degree of amination of the hydroxy- and amino-functional polybutadiene (E) corresponds to the degree of epoxidation of the corresponding epoxy-functional polybutadiene (C).

### Step c)

In step c) of the process according to the invention, the at least one hydroxy- and amino-functional polybutadiene (E) is reacted with at least one epoxy-functional compound (F) to give at least one polyether-modified amino-functional polybutadiene (G).

The at least one hydroxy- and amino-functional polybutadiene (E) from step b) serves, in step c), as starter compound (starter) for the reaction with the at least one epoxy-functional compound (F). Under ring-opening and preferably in the presence of a suitable catalyst, the at least one epoxy-functional compound (F) (also referred to hereinafter simply as “monomer” or “epoxy monomer” or “epoxide”) is added onto the NH and/or OH groups of the at least one hydroxy- and amino-functional polybutadiene (E) in a polyaddition reaction. This leads to the formation of amino-functional polybutadienes with polyether chains in comb (pendant) positions, i.e. to the formation of the at least one polyether-modified amino-functional polybutadiene (G). The monomers are preferably added onto (at least largely) all OH groups and onto (at least largely) all NH groups. The polyether-modified amino-functional polybutadiene (G) is preferably a linear polybutadiene which has been modified with polyether radicals in comb (pendant) positions. It is thus preferable that the polyether-modified amino-functional polybutadiene (G) has a linear polybutadiene backbone and pendant polyether radicals.

The reaction in step c) is preferably an alkoxylation reaction, i.e. a polyaddition of alkylene oxides onto the at least one hydroxy- and amino-functional polybutadiene (E). However, the reaction in step c) may also be conducted with glycidyl compounds alternatively or additionally to the alkylene oxides.

It is therefore preferable that the at least one epoxy-functional compound used in step c) is selected from the group of the alkylene oxides, more preferably from the group of the alkylene oxides having 2 to 18 carbon atoms, even more preferably from the group of the alkylene oxides having 2 to 8 carbon atoms, most preferably from the group consisting of ethylene oxide, propylene oxide, 1-butylene oxide, cis-2-butylene oxide, trans-2-butylene oxide, isobutylene oxide and styrene oxide; and/or in that the at least one epoxy-functional compound used in step c) is selected from the group of the glycidyl compounds, more preferably from the group of the monofunctional glycidyl compounds, most preferably from the group consisting of phenyl glycidyl ether, o-cresyl glycidyl ether, tert-butylphenyl glycidyl ether, allyl glycidyl ether, butyl glycidyl ether, 2-ethylhexyl glycidyl ether, C₁₂/C₁₄ fatty alcohol glycidyl ether and C₁₃/C₁₅ fatty alcohol glycidyl ether.

The monomers may be added alternatively individually in pure form, in alternating succession in any metering sequence, or else simultaneously in mixed form. The sequence of monomer units in the resulting polyether chain is thus subject to a blockwise distribution or a statistical distribution or a gradient distribution in the end product.

By the process according to the invention, pendant polyether chains are constructed on the polybutadiene, which are exemplified in that they can be prepared in a controlled and reproducible manner in terms of structure and molar mass.

The sequence of monomer units can be varied by the sequence of addition within broad limits.

The molar masses of the pendant polyether radicals may be varied within broad limits by the process according to the invention, and controlled specifically and reproducibly via the molar ratio of the added monomers in relation to the NH and OH groups of the at least one initially charged hydroxy- and amino-functional polybutadiene (E) from step b).

The polyether-modified amino-functional polybutadienes (G) and also the corresponding hydrogenated polyether-modified amino-functional polybutadienes (H) prepared therefrom are preferably characterized in that they contain B radicals bonded to the polybutadiene backbone via an amino and/or ether group according to the formulae (3a), (3b) and (3c),

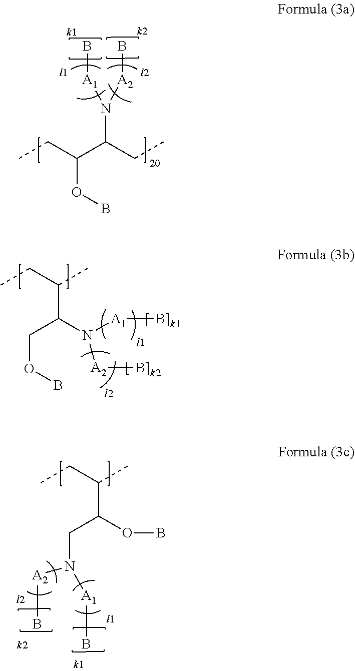

The radicals A₁ and A₂ are each independently organic radicals preferably having 1 to 22, most preferably having 1 to 12 carbon atoms, where the radicals A₁ and A₂ may be covalently bonded to each other. The radicals A₁ and A₂ may in this case comprise heteroatoms, preferably nitrogen and oxygen.

The indices k1 and k2 in the formulae (3a), (3b) and (3c) are each independently integers from 0 to 8, preferably from 0 to 6, most preferably from 0 to 4. In addition, the indices 11 and 12 in the formulae (3a), (3b) and (3c) are integers and each independently either 0 or 1. The radicals B formed by alkoxylation may therefore be bound k1-fold and k2-fold to the radicals A₁ and A₂ respectively, where the chemical bond is formed via a nitrogen atom or an oxygen atom, which is part of A₁ and A₂. The radicals B formed by alkoxylation, however, may also be bonded directly to the nitrogen atom shown. If, in the formulae (2a), (2b) or (2c), the radical A₁ or A₂ is a hydrogen radical, then in the formulae (3a), (3b) or (3c) index 11 and 12 equal 0 and k1 and k2 equal 1, i.e. the corresponding radical A₁ or A₂ in the formulae (3a), (3b) and (3c) is non-existent and thus a polyether B radical is bonded directly to the nitrogen atom shown. An N—H group in the formulae (2a), (2b) or (2c) is therefore replaced by an N—B group. If, in the formulae (2a). (2b) or (2c), the radical A₁ or A₂ is an organic radical, then in the formulae (3a), (3b) or (3c) index 11 or 12 equal 1. If, in the formulae (2a), (2b) or (2c), both A₁ and A₂ are hydrogen radicals, then in the formulae (3a). (3b) or (3c) the indices 11 and 12 equal 0 and k1 and k2 equal 1, i.e. the radicals A₁ and A₂ in the formulae (3a), (3b) and (3c) are non-existent and the polyether radicals B are bonded directly to the nitrogen atom shown. Both N—H groups in the formulae (2a), (2b) or (2c) are therefore each replaced by an N—B group.

If a primary alkylamine, for example, is used as amino-functional compound (D) in step b), and the alkyl radical has no other groups reactive to epoxides, for example OH or NH groups, then 11=1, k1=0, 12=0 and k2=1 for example.

If the primary amine ethanolamine, for example, is used as amino-functional compound (D) in step b), then A₁ is a divalent radical of the formula-CH₂CH₂O— for example, which, in this illustration, is bonded on the left to the nitrogen atom of the amino group via the carbon atom and is bonded on the right to a B radical via the oxygen atom. i.e. 11=1, k1=1, 12=0 and k2=1 for example.

If the primary amine tris(hydroxymethyl)aminomethane (TRIS, 2-amino-2-(hydroxymethyl)propane-1,3-diol), for example, is used as amino-functional compound (D) in step b), then A₁ is a tetravalent radical of the formula-C(CH₂O—)₃ for example, which, in this illustration, is bonded on the left to the nitrogen atom of the amino group via the carbon atom and is bonded in each case on the right to a B radical via the three oxygen atoms (and thus to three B radicals in total), i.e. 11=1, k1=3, 12=0 and k2=1 for example.

If the secondary amine diethanolamine, for example, is used as amino-functional compound (D) in step b), then A₁ and A₂ are divalent radicals of the formula-CH₂CH₂O— for example, which, in this illustration, are bonded on the left to the nitrogen atom of the amino group via the carbon atom and are bonded on the right to a B radical via the oxygen atom, i.e. 11=1, k1=1, 12=1 and k2=1.

If the secondary amine N-methylethanolamine, for example, is used as amino-functional compound (D) in step b), then A: is a methyl group and A₂ is a divalent radical of the formula-CH₂CH₂O— for example, which, in this illustration, is bonded on the left to the nitrogen atom of the amino group via the carbon atom and is bonded on the right to the B radical via the oxygen atom, i.e. 11=1, k1=0, 12=1 and k2=1.

If the secondary amine piperidine, for example, is used as amino-functional compound (D) in step b), then A₁ and A₂ are covalently bonded to each other and together form the divalent radical-CH₂CH₂CH₂CH₂CH₂—, which, in this illustration, is bonded both on the left and right to the nitrogen atom of the amino group, i.e.: 11=1, k1=0, 12=1 and k2=0.

Therefore, in the alkoxylation reaction, there results preferably in each case precisely one pendant B radical from (at least almost) every pendant OH and NH group of the at least one hydroxy- and amino-functional polybutadiene (E). The B radical is in turn constructed from one or more monomers, preferably from two or more monomers, of the at least one epoxy-functional compound (F) used. It is possible, although less preferable, that in the alkoxylation reaction not every OH or NH group of the hydroxy- and amino-functional polybutadiene (E) results in a pendant B radical, rather that only some, but preferably the overwhelming majority of the OH and NH groups are reacted in step c).

In the context of the invention, it is possible in principle to use all alkoxylation catalysts known to the person skilled in the art, for example basic catalysts such as alkali metal hydroxides, alkali metal alkoxides, amines, guanidines, amidines, phosphorus compounds such as phosphines (for example triphenylphosphine), and additionally Brønsted-acidic and Lewis-acidic catalysts such as SnCl₄, SnCl₂, SnF₂, BF₃ and BF₃ complexes, and also double metal cyanide (DMC) catalysts. Optionally, the addition of a catalyst can be omitted.

Prior to the feeding of epoxide, i.e. prior to the addition of the at least one epoxy-functional compound (F) used, the reactor partly filled with the starter and optionally the catalyst is inertized, for example with nitrogen. This is accomplished, for example, by repeated alternating evacuation and supply of nitrogen. It is advantageous to evacuate the reactor to below 200 mbar after the last injection of nitrogen. This means that the addition of the first amount of epoxy monomer preferably takes place in the evacuated reactor. The monomers are dosed while stirring and optionally cooling in order to remove the heat of reaction released and to maintain the preselected reaction temperature. The starter used is the at least one hydroxy- and amino-functional polybutadiene (E), or else it is possible to use a polyether-modified amino-functional polybutadiene (G) already prepared by the process of the invention as starter, as described further below.

In a particular embodiment, when starting the monomer addition, the addition of a catalyst can be omitted. This is the case, for example when the amino groups bonded to the polybutadiene are sufficiently reactive. If a sufficient number of nucleophilic NH functions are present on the polybutadiene, the starter itself catalyzes the alkoxylation reaction. The reaction rate generally declines with the polyether chain length. To achieve higher molecular weight polyether B radicals, it may be necessary or beneficial to add one of the aforementioned catalysts to the alkoxylation reaction at a later time point.

### DMC Catalysis

Preference is given to using zinc/cobalt DMC catalysts, in particular those containing zinc hexacyanocobaltate(III). Preference is given to using the DMC catalysts described in U.S. Pat. No. 5,158,922, US 20030119663, WO 01/80994. The catalysts may be amorphous or crystalline.

It is preferable that the catalyst concentration is from >0 ppmw to 1000 ppmw, more preferably from >0 ppmw to 700 ppmw, most preferably from >10 ppmw to 500 ppmw, based on the total mass of the products formed.

The catalyst is preferably metered into the reactor only once. The catalyst should preferably be clean, dry and free of basic impurities that could inhibit the DMC catalyst. The amount of catalyst should preferably be set so as to give sufficient catalytic activity for the process. The catalyst may be metered in in solid form or in the form of a catalyst suspension. If a suspension is used, then a particularly suitable suspension medium is the starter.

In order to start the DMC-catalyzed reaction, it may be advantageous first to activate the catalyst with a portion of the at least one epoxy-functional compound (F), preferably selected from the group of the alkylene oxides, especially with propylene oxide and/or ethylene oxide. Once the alkoxylation reaction is underway, the continuous addition of the monomer may be commenced.

The reaction temperature in the case of a DMC-catalyzed reaction in step c) is preferably 60° C. to 200° C., more preferably 90° C. to 160° C. and most preferably 100° C. to 140° C.

The internal reactor pressure in the case of a DMC-catalyzed reaction in step c) is preferably from 0.02 bar to 100 bar, more preferably from 0.05 bar to 20 bar, most preferably from 0.1 bar to 10 bar (absolute).

Most preferably, a DMC-catalyzed reaction in step c) is conducted at a temperature of 100° C. to 140° C. and a pressure of 0.1 bar to 10 bar.

The reaction may be performed in a suitable solvent, for example for the purpose of lowering the viscosity. At the end of the epoxide addition, there preferably follows a period of further reaction to allow the reaction to proceed to completion. The further reaction may for example be conducted by continued reaction under the reaction conditions (i.e. with maintenance of e.g. the temperature) without addition of reactants. The DMC catalyst typically remains in the reaction mixture.

Once the reaction has taken place, unreacted epoxides and any other volatile constituents can be removed by vacuum distillation, steam- or gas-stripping, or other methods of deodorization. The finished product is finally filtered at <100° C. in order to remove any cloudy substances present.

### Base Catalysis

As an alternative to the DMC catalysts, it is also possible to use basic catalysts in step c). Especially suitable are alkali metal alkoxides such as sodium methoxide and potassium methoxide, which are added in solid form or in the form of their methanolic solutions. In addition, it is possible to use all alkali metal hydroxides, especially sodium hydroxide and/or potassium hydroxide, either in solid form or in the form of aqueous or alcoholic solutions, for example. In addition, it is also possible in accordance with the invention to use basic nitrogen compounds, preferably amines, guanidines and amidines, most preferably tertiary amines such as trimethylamine and triethylamine.

It is preferable to use the basic catalysts at a concentration of >0 mol % to 100 mol %, more preferably >0 mol % to 50 mol %, most preferably 3 mol % to 40 mol %, based on the sum total of OH and NH groups in the starter.

The reaction temperature in the case of a base-catalyzed reaction in step c) is preferably 80° C. to 200° C., more preferably 90° C. to 160° C. and most preferably 100° C. to 160° C.

The internal reactor pressure in the case of a base-catalyzed reaction in step c) is preferably from 0.2 bar to 100 bar, more preferably from 0.5 bar to 20 bar, most preferably from 1 bar to 10 bar (absolute).

Most preferably, the base-catalyzed reaction in step c) is conducted at a temperature of 100″° C. to 160° C. and a pressure of 1 bar to 10 bar.

The reaction may optionally be performed in a suitable solvent. After the epoxide addition has ended, there preferably follows a period of further reaction to allow the reaction to proceed to completion. The further reaction can be conducted, for example, by continued reaction under reaction conditions without addition of reactants. Once the reaction has proceeded to completion, unreacted epoxides and any further volatile constituents can be removed by vacuum distillation, steam or gas stripping, or other methods of deodorization. Volatile catalysts, such as volatile amines, are removed here.

For neutralization of the basic crude products, acids such as phosphoric acid or sulfuric acid or carboxylic acids such as acetic acid and lactic acid are added. Preference is given to the use of aqueous phosphoric acid and lactic acid. The amount of the respective acid used is guided by the amount of basic catalyst used beforehand. The basic polybutadiene with pendant polyether radicals is stirred in the presence of the acid at preferably 40° C. to 95° C. and then distilled to dryness in a vacuum distillation at <100 mbar and 80° C. to 130° C. The neutralized product is finally filtered, preferably at <100° C., in order to remove precipitated salts.

It is preferable that the end products according to the invention have a water content of <0.2% (specified as proportion by mass based on the total mass of the end product) and an acid number of <0.5 mg KOH/g and are virtually phosphate-free.

### Products as Starters

It is not always possible to achieve the desired molar mass of the end product in just a single reaction step, especially the alkoxylation step. Particularly when long polyether side chains are the aim and/or the starter from step b), i.e. the at least one hydroxy- and amino-functional polybutadiene (E), has a high OH and NH group functionality, it is necessary to add large amounts of epoxy monomers. This is sometimes not permitted by the reactor geometry. The polyether-modified amino-functional polybutadienes (G) from step c) bear an OH-group at the ends of each of their pendant polyether radicals, and are therefore suitable in turn as starter for construction of conversion products of high molecular weight. In the context of the invention, they are precursors and starter compounds for the synthesis of polybutadienes having relatively long polyether radicals. The at least one epoxy-functional compound (F) can thus be converted in step c) in multiple component steps.

A product prepared with the aid of DMC catalysis in step c) may, in accordance with the invention, have its level of alkoxylation increased by new addition of epoxy monomers, alternatively by means of DMC catalysis or with use of one of the aforementioned basic or acidic catalysts. It is optionally possible to add a further DMC catalyst in order, for example, to increase the reaction rate in the chain extension.

A product prepared under base catalysis from step c) may likewise be alkoxylated to higher molar masses alternatively under basic or acidic conditions or by means of DMC catalysis. In step c), neutralization is advantageously dispensed with if the aim is to react the basic precursor further with monomers under base catalysis. It is optionally possible to add a further basic catalyst in order, for example, to increase the reaction rate in the chain extension.

### Step d)

In process step d) according to the invention, the at least one polyether-modified amino-functional polybutadiene (G) is hydrogenated to give at least one hydrogenated polyether-modified amino-functional polybutadiene (H).

Here, the C═C double bonds of the polyether-modified amino-functional polybutadiene (G) are partially or fully hydrogenated. The C═C double bonds are therefore partially or completely converted to C—C single bonds.

A unit (X), if hydrogenated, is converted to a unit (V) and a unit (Y) or (Z) is correspondingly converted to a unit (W):

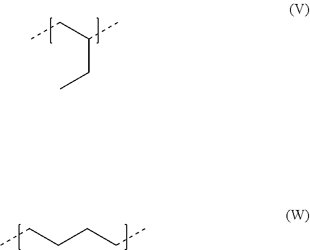

In this case, preferably at least 30%, more preferably at least 60%, even more preferably at least 90%, especially preferably at least 95% of the double bonds present in the polyether-modified polybutadiene (G) are hydrogenated. The degree of hydrogenation is preferably determined with the aid of 1H-NMR spectroscopy, in particular as described in the examples.

It is further preferable that solvents are used in the hydrogenation, since the hydrogenated polyether-modified amino-functional polybutadienes (H) usually have high viscosities. Solvents that may be used advantageously are, for example, water, alkanes, isoalkanes, cycloalkanes, alkylaromatics, alcohols, ethers and/or esters, alone or in a mixture. Advantageously employable alkanes are for example n-hexane, n-heptane, n-octane, n-nonane, n-decane, n-undecane and/or n-dodecane. Advantageously employable cycloalkanes are for example cyclohexane, methylcyclohexane, cycloheptane, cyclooctane, cyclononane, cyclodecane, cycloundecane, cyclododecane and/or decalin. Advantageously employable alkylaromatics are toluene, xylene, cumene, n-propylbenzene, ethylmethylbenzene, trimethylbenzene, solvent naphtha and/or any alkylbenzenes available on a large industrial scale. Advantageously employable alcohols are, for example, n-propyl alcohol, isopropyl alcohol and n-butyl alcohol. An advantageously employable ether is, for example, tetrahydrofuran and advantageously employable esters are, for example, ethyl acetate and butyl acetate. Particularly advantageously employable are aromatic solvents such as toluene, xylene and cumene or high-boiling esters such as butyl acetate, particular preference being given to using xylene and/or butyl acetate. The amount of solvent that may be used advantageously can be readily adjusted to the specific application by those skilled in the art. Preference is given to using between 0 and 90% by weight solvent, based on the total mass of polyether-modified amino-functional polybutadienes (G) and solvent, more preferably between 10 and 85%, even more preferably between 30 and 80% and most preferably between 50 and 75%.

The hydrogenation can be advantageously carried out in a pressure autoclave. By means of addition of hydrogen to the closed reaction vessel, a positive pressure, i.e. an elevated pressure compared to atmospheric pressure, is generated. Preferred pressures are between 1 bar and 100 bar, more preferably between 2 bar and 50 bar, most preferably between 3 bar and 10 bar.

Furthermore, hydrogenation in the so-called bubble method is also advantageously feasible. In this process, the reaction mixture is carried out in an open reaction vessel, in which hydrogen is introduced continuously below the surface. In this case, the hydrogenation is therefore carried out under atmospheric pressure.

Regardless of whether the hydrogenation is carried out under atmospheric pressure or under positive pressure, it is preferable to ensure sufficiently good mixing of the reaction system.

The temperature in the hydrogenation is variable within wide ranges and is adjusted to the specific reaction system of catalyst and polyether-modified amino-functional polybutadienes (G). It is preferable that the temperature is between 25° C. and 200° C., more preferably between 60° C. and 175° C. and most preferably between 100° C. and 150° C.

It is preferable that the hydrogenation is carried out with hydrogen in the presence of at least one hydrogenation catalyst.

In principle, all hydrogenation catalysts known to those skilled in the art may be used as catalysts, alone or in a mixture of two or more catalysts. The use of homogeneous and/or heterogeneous catalysts may be advantageous, the use of heterogeneous catalysts being preferred due to the ease of removal after hydrogenation.

Preferred employable noble metal catalysts, for example, are based on platinum, palladium, rhodium, iridium and ruthenium. Advantageous non-noble metal catalysts, for example, are based on nickel, copper, cobalt, manganese, molybdenum, tungsten and/or titanium. All catalysts may be used in supported form or in pure (i.e. unsupported) form.

Further preference is given to hydrogenation catalysts based on nickel, palladium, rhodium and/or ruthenium. Still more preference is given to using Raney nickel, palladium on activated carbon, ruthenium on activated carbon or rhodium as Wilkinson's catalyst (chloridotris(triphenylphosphine) rhodium(I)). Particular preference is given to using Raney nickel, palladium on activated carbon and/or Wilkinson's catalyst as hydrogenation catalyst. If mixtures of two or more of the aforementioned hydrogenation catalysts are used, then a mixture of Raney nickel and palladium on activated carbon is preferred.

The amount of catalyst used may be adjusted to the particular application. The amount used is selected so that at least hydrogenation can take place. The amount of catalyst used is preferably between 0.1% by weight and 10% by weight, more preferably between 0.2% by weight and 7% by weight, most preferably between 0.3% by weight and 5% by weight, based on the amount used of the polyether-modified amino-functional polybutadiene (G) to be hydrogenated.

After hydrogenation is complete, the reaction mixture is preferably filtered in order to remove solids present such as the heterogeneous catalyst. Depending on the viscosity of the reaction mixture, it may be advantageous to dilute the reaction mixture prior to filtration with a suitable solvent, preferably butyl acetate or xylene.

Lastly, the filtrate obtained after filtration is distilled in order to remove highly volatile components such as solvent present and to isolate the pure hydrogenated polyether-modified amino-functional polybutadiene (H) according to the invention.

### Optional Steps Cc) and Dd)

In an optional step cc), the at least one polyether-modified amino-functional polybutadiene (G) without end-capped polyether radicals may be reacted with at least one endcapping reagent (I) to give at least one polyether-modified amino-functional polybutadiene (G) comprising end-capped polyether radicals.

In step cc), therefore, the at least one polyether-modified amino-functional polybutadiene without end-capped polyether radicals (G1) may be reacted with at least one end-capping reagent (I) to give at least one polyether-modified amino-functional polybutadiene comprising end-capped polyether radicals (G2).

As an alternative to optional step cc), in an optional step dd), the at least one hydrogenated polyether-modified amino-functional polybutadiene (H) without end-capped polyether radicals may be reacted with at least one end-capping reagent (I) to give at least one hydrogenated polyether-modified amino-functional polybutadiene (H) comprising end-capped polyether radicals.

In step dd), therefore, the at least one hydrogenated polyether-modified amino-functional polybutadiene without end-capped polyether radicals (H1) may be reacted with at least one end-capping reagent (I) to give at least one hydrogenated polyether-modified amino-functional polybutadiene comprising end-capped polyether radicals (H2).

“End-capped polyether radicals” are understood to mean those polyether radicals having no hydroxyl groups.

In steps cc) and dd), the B radicals of the polybutadienes (G1) or (H1) having terminal hydroxyl groups are reacted preferably to give ester, ether, urethane and/or carbonate groups. The endcapping of polyethers is known to those skilled in the art, for example esterification with carboxylic acids or carboxylic anhydrides, in particular acetylation using acetic anhydride, etherification with halogenated hydrocarbons, in particular methylation with methyl chloride according to the principle of the Williamson ether synthesis, urethanization by reaction of the OH groups with isocyanates, in particular with monoisocyanates such as stearyl isocyanate, and carbonation by reaction with dimethyl carbonate and diethyl carbonate.

### Optional Step e)

In an optional step e), the at least one hydrogenated amino-functional polyether-modified polybutadiene (H) may be lightened in colour.

The hydrogenated amino-functional polyether-modified polybutadiene (H) may be in this case a polyether-modified amino-functional polybutadiene without end-capped polyether radicals (H1) and/or a polyether-modified amino-functional polybutadiene with end-capped polyether radicals (H2).

The colour lightening can be effected, for example, by adding activated carbon, preferably in a suitable solvent, or by treatment with hydrogen peroxide. The colour lightening can be determined preferably via the Gardner colour number (determined in accordance with DIN EN ISO 4630). It is preferred here that the Gardner colour number of the hydrogenated polyether-modified polybutadiene (H) is reduced in terms of the colour lightening by at least 1, preferably by at least 2.

### Optional Step f)

In an optional step f), at least some of the amino groups of the at least one polyether-modified amino-functional polybutadiene (G) may be reacted with an acid or a quaternizing reagent such as alkyl halides and benzyl halides, dimethyl sulfate or chloroacetic acid or sodium chloroacetate to give quaternary ammonium groups.

The hydrogenated amino-functional polyether-modified polybutadiene (H) may be in this case a polyether-modified amino-functional polybutadiene without end-capped polyether radicals (H1) and/or a polyether-modified amino-functional polybutadiene with end-capped polyether radicals (H2).

Step f) may alternatively be carried out after step d) or after optional step e). After quaternization, the products may be dissolved or dispersed, for example in water or organic solvents.

### Hydrogenated Polyether-Modified Amino-Functional Polybutadienes

The present invention further provides hydrogenated amino-functional polybutadienes modified with polyether radicals in comb (pendant, lateral) positions, as preparable by the process according to the invention.

The invention therefore further provides a hydrogenated polyether-modified amino-functional polybutadiene (H) obtainable by the process according to the invention.

The hydrogenated polyether-modified amino-functional polybutadiene (H) is preferably a linear, at least partially hydrogenated polybutadiene which has been modified with polyether radicals in comb (pendant, lateral) positions. It is thus preferable that the hydrogenated polyether-modified amino-functional polybutadiene (H) has a linear, at least partially hydrogenated polybutadiene backbone and pendant polyether radicals.

The invention likewise further provides a hydrogenated polyether-modified amino-functional polybutadiene (H), which is obtainable preferably by the process according to the invention, characterized in that the hydrogenated polyether-modified amino-functional polybutadiene (H) comprises units selected
both from the group consisting of the divalent radicals (S), (T) and (U):

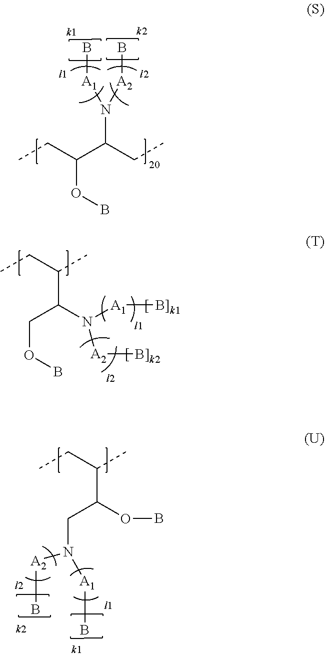

and from the group consisting of the divalent radicals (V) and (W):

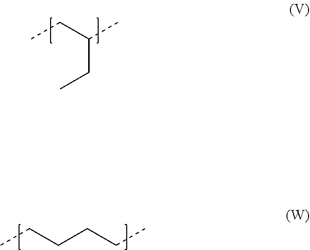

and optionally from the group consisting of the divalent radicals (X), (Y) and (Z):

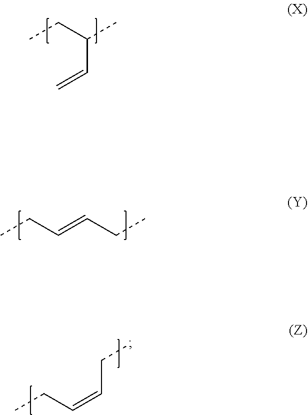

where
A₁ and A₂ are each independently organic radicals preferably having 1 to 22 carbon atoms, most preferably having 1 to 12 carbon atoms, where the radicals A₁ and A₂ may be covalently bonded to each other,
B is each independently a radical of the formula (4a),

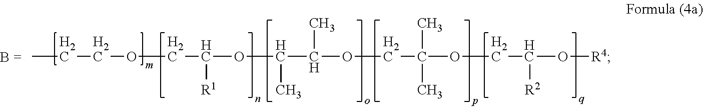

preferably is each independently a radical of the formula (4b),

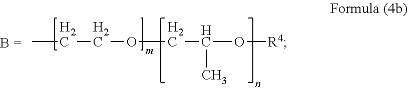

most preferably is each independently a radical of the formula (4c),

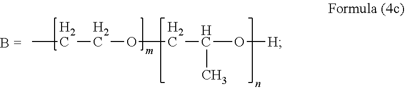

R¹ is each independently a monovalent hydrocarbon radical having 1 to 16 carbon atoms; preferably each independently an alkyl radical having 1 to 16 carbon atoms or a phenyl radical;
   most preferably each independently a methyl radical, an ethyl radical or a phenyl radical;
R² is a radical of the formula-CH₂—O—R³;
R³ is each independently a monovalent hydrocarbon radical having 3 to 18 carbon atoms;
preferably each independently an allyl radical, a butyl radical, an alkyl radical having 8 to 15 carbon atoms or a phenyl radical that may be substituted by monovalent radicals selected from hydrocarbon radicals having 1 to 4 carbon atoms;
   most preferably a tert-butylphenyl radical or an o-cresyl radical;
R⁴ is each independently a monovalent organic radical having 1 to 18 carbon atoms or hydrogen, preferably hydrogen;
and
k1 and k2 are each independently integers from 0 to 8, preferably from 0 to 6, most preferably from 0 to 4;
I1 and I2 are integers and each independently either 0 or 1;
m, n, o, p and q are each independently rational numbers from 0 to 300, preferably from 0 to 200, most preferably from 0 to 100, with the proviso that the sum total of m, n, o, p and q is greater than 1, preferably greater than 5, most preferably greater than 10;
and each permutation of the units in the B radical, the number of which is specified by the indices m, n, o, p and q, is included.

The term “hydrogen” for a radical is a hydrogen radical.

The radicals R¹, R², R³ and R⁴ may each independently be linear or branched, saturated or unsaturated, aliphatic or aromatic, and substituted or unsubstituted.

The general notation

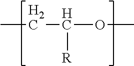

with R=R¹ or R² in formula (4a) or R═CH₃ in the formulae (4b) and (4c) represents either a unit of the formula

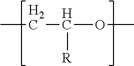

or a unit of the formula

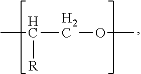

but preferably a unit of the formula

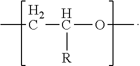

The general notation

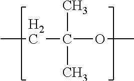

in formula (4a) represents either a unit of the formula

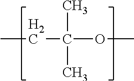

or a unit of the formula

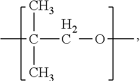

but preferably a unit of the formula

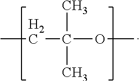

It is further preferable that the radical R⁴ is each independently selected from the group consisting of monovalent hydrocarbon radicals having 1 to 18 carbon atoms, acyl radicals-C(═O)R⁵, urethane radicals —C(═O)NH—R⁵, carbonate radicals-C(═O)O—R⁷ and hydrogen: R⁴ is more preferably each independently selected from the group consisting of alkyl radicals having 1 to 18 carbon atoms, alkylene radicals having 1 to 18 carbon atoms, acyl radicals-C(═O)R⁵, urethane radicals-C(═O)NH—R⁶, carbonate radicals —C(═O)O—R⁷ and hydrogen; most preferably, R⁴ is hydrogen, where the term “hydrogen” denotes a hydrogen radical.

R⁵ is each independently an alkyl or alkenyl radical having 1 to 18 carbon atoms, preferably having 1 to 10 carbon atoms, most preferably a methyl radical.

R⁶ is each independently an alkyl or aryl radical having 1 to 18 carbon atoms, preferably having 6 to 18 carbon atoms.

R⁷ is each independently an alkyl radical having 1 to 18 carbon atoms, preferably having 1 or 2 carbon atoms.

In accordance with the invention, the sum total (the total number) of all units (S), (T) and (U) divided by the sum total (the total number) of all units (S), (T). (U), (V). (W), (X). (Y) and (Z) of the at least one hydrogenated polyether-modified amino-functional polybutadiene (H) is from >0% to <100%.

This means, conversely, that the sum total (the total number) of all units (V), (W), (X), (Y) and (Z) divided by the sum total (the total number) of all units (S), (T), (U), (V), (W), (X), (Y) and (Z) of the at least one hydrogenated polyether-modified amino-functional polybutadiene (H) is from <100% to >0%.

This means that >0% to <100% of the totality of the units (S), (T), (U), (V), (W), (X), (Y) and (Z) are polyether-modified.

This also means that <100% to >0% of the totality of the units (S), (T), (U), (V), (W), (X). (Y) and (Z) are not polyether-modified.

It is preferable in this case that the sum total (the total number) of all units (S), (T) and (U) divided by the sum total (the total number) of all units (S), (T), (U), (V), (W), (X), (Y) and (Z) of the at least one hydrogenated polyether-modified amino-functional polybutadiene (H) is from >0% to 70%, more preferably from 1% to 50%, still more preferably from 2% to 40%, even more preferably from 3% to 30%, most preferably from 4% to 20%.

This means that preferably from >0% to 70%, more preferably from 1% to 50%, even more preferably from 2% to 40%, still more preferably from 3% to 30%, most preferably from 4% to 20% of the totality of units (S), (T), (U), (V), (W), (X), (Y) and (Z) are polyether-modified.

It is further preferable in this case that the sum total (the total number) of all units (V). (W), (X), (Y) and (Z) divided by the sum total (the total number) of all units (S), (T), (U), (V), (W), (X), (Y) and (Z) of the at least one hydrogenated polyether-modified amino-functional polybutadiene (H) is from <100% to 30%, more preferably from 99% to 50%, still more preferably from 98% to 60%, even more preferably from 97% to 70%, most preferably from 96% to 80%.

This means that preferably from <100% to 30%, even more preferably from 99% to 50%, even more preferably from 98% to 60%, still more preferably from 97% to 70%, most preferably from 96% to 80% of the totality of units (S), (T), (U), (V). (W), (X), (Y) and (Z) are not polyether-modified.

The hydrogenated polyether-modified amino-functional polybutadiene (H) may be partially hydrogenated or fully hydrogenated.

It is therefore further preferable that the sum total (the total number) of all units (V) and (W) divided by the sum total (the total number) of all units (V), (W), (X), (Y) and (Z) of the at least one hydrogenated polyether-modified polybutadiene (H) is at least 30%, more preferably at least 60%, even more preferably at least 90%, especially preferably at least 95%. This means that at least 30%, more preferably at least 60%, even more preferably at least 90%, especially preferably at least 95% of the totality of the units (V), (W), (X), (Y) and (Z) are saturated, and that less than 30%, more preferably less than 40%, even more preferably less than 10%, especially preferably less than 5% of the totality of the units (V), (W), (X), (Y) and (Z) are unsaturated. This is preferably determined with the aid of ¹H-NMR spectroscopy, in particular as described in the examples.

It should be noted that the polyether B radicals may be unsaturated, for example if R¹ and/or R³ is a phenyl radical. However, aromatic groups are preferably not hydrogenated and are unchanged after the hydrogenation.

The number-average molar mass Mₙ, weight-average molar mass M_{w} and polydispersity of the polybutadiene moiety of the hydrogenated polyether-modified amino-functional polybutadiene (H) are freely variable. The polybutadiene moiety is understood to mean the component of the hydrogenated polyether-modified amino-functional polybutadiene (H) that originates from the polybutadiene (A) used in the process. The number-average molar mass Mₙ, weight-average molar mass M_{w} and polydispersity of the polybutadiene moiety of the hydrogenated polyether-modified amino-functional polybutadiene (H) is therefore identical to the number-average molar mass Mₙ, weight-average molar mass M_{w} and polydispersity of the polybutadiene (A) from which the hydrogenated polyether-modified amino-functional polybutadiene (H) has been prepared.

It is preferable that the number-average molar mass Mₙ of the polybutadiene moiety of the hydrogenated polyether-modified amino-functional polybutadiene (H) is from 200 g/mol to 20 000 g/mol, more preferably from 500 g/mol to 10 000 g/mol, most preferably from 700 g/mol to 5000 g/mol.

Alternatively, it is preferable that the number-average molar mass Mₙ of the polybutadiene moiety of the hydrogenated polyether-modified amino-functional polybutadiene (H) is from 2100 g/mol to 20 000 g/mol, more preferably from 2200 g/mol to 10 000 g/mol, most preferably from 2300 g/mol to 5000 g/mol.

The number-average molar mass Mₙ of the polybutadiene component is defined here as the number-average molar mass Mₙ of the underlying polybutadiene (A).

It is further preferable that the hydrogenated polyether-modified amino-functional polybutadiene (H) has an average of 5 to 360, preferably 10 to 180, most preferably 15 to 90 units, where the units are selected from the group consisting of (S), (T), (U), (V), (W), (X), (Y) and (Z).

Alternatively, it is preferable that the polyether-modified amino-functional polybutadiene (H) has an average of 35 to 360, preferably 40 to 180, most preferably 45 to 90 units, where the units are selected from the group consisting of (S), (T), (U), (V), (W), (X), (Y) and (Z).

It is preferable that the proportion by mass of all units (S), (T), (U), (V), (W), (X), (Y) and (Z) taken together, based on the total mass of the at least one hydrogenated polyether-modified amino-functional polybutadiene (H) is at least 50%, even more preferably at least 60%, still more preferably at least 70%, preferably at least 80%, even more preferably at least 90%, still more preferably at least 95%, still more preferably at least 99%, especially preferably 100%.

It is preferable that the hydrogenated polyether-modified amino-functional polybutadiene (H) substantially or fully consists of the units (S), (T), (U), (V), (W), (X), (Y) and (Z). It is particularly preferable that the hydrogenated polyether-modified amino-functional polybutadiene (H) substantially or fully consists of the units (S), (T), (U), (V) and (W).

It is particularly preferable that the hydrogenated polyether-modified amino-functional polybutadienes (H) are characterized in that the proportion by mass of units (S) is at least 95%, based on the total mass of all units (S). (T), (U).

Most preferred are those hydrogenated polyether-modified amino-functional polybutadienes (H) which are derived from the polybutadienes (A) Polyvest® 110 and Polyvest® 130 from Evonik Industries AG/Evonik Operations GmbH and Lithene ultra AL and Lithene ActiV 50 from Synthomer PLC described above.

The molar mass and polydispersity of the B radicals is freely variable. However, it is preferable that the average molar mass of the B radical is from 30 g/mol to 20 000 g/mol, more preferably from 50 g/mol to 10 000 g/mol, even more preferably from 100 g/mol to 5000 g/mol, most preferably from 150 g/mol to 1000 g/mol. The average molar mass of the B radicals may be calculated from the starting weight of the monomers used based on the number of OH and NH groups of the hydroxy- and amino-functional polybutadiene (E) used. Thus, for example, if 40 g of ethylene oxide are used and the total amount of all OH and NH groups of the hydroxy- and amino-functional polybutadiene (E) used is together 0.05 mol, the average molar mass of the B radical is 800 g/mol.

The hydrogenated polyether-modified amino-functional polybutadienes (H) are liquid, pasty or solid according to the composition and molar mass.

The number-average molar mass (Mₙ) of the at least one hydrogenated polyether-modified amino-functional polybutadiene (H) is preferably from 1000 g/mol to 50 000 g/mol, more preferably from 1500 g/mol to 40 000 g/mol, even more preferably from 2000 g/mol to 30 000 g/mol, most preferably from 3000 g/mol to 10 000 g/mol.

Their polydispersity (M_{w}/Mₙ) is variable within broad ranges. The polydispersity of the at least one hydrogenated polyether-modified amino-functional polybutadiene (H) is preferably from 1.5 to 10, more preferably from 2 to 8, most preferably from 3 to 5.

The examples that follow describe the present invention by way of example, without any intention that the Invention, the scope of application of which is evident from the entirety of the description and the claims, be restricted to the embodiments specified in the examples.

### EXAMPLES

### General Methods:

### Gel Permeation Chromatography (GPC):

GPC measurements for determination of the polydispersity (M_{w}/Mₙ), weight-average molar mass (M_{w}) and number-average molar mass (Mₙ) of the epoxy-functional polybutadiene (C) were carried out under the following measurement conditions: SDV 1000/10 000 Å column combination (length 65 cm), temperature 30° C., THF as mobile phase, flow rate 1 ml/min, sample concentration 10 g/l, RI detector, evaluation against polypropylene glycol standard. GPC measurements for determination of the polydispersity (M_{w}/Mₙ), weight-average molar mass (M_{w}) and number-average molar mass (Mₙ) of the polybutadienes (A) may be conducted in the same manner.

GPC measurements for determination of the polydispersity (M_{w}/Mₙ), weight-average molar mass (M_{w}) and number-average molar mass (Mₙ) of the polyether-modified amino-functional polybutadienes (G) in accordance with the invention were carried out under the following measurement conditions: Jordi DVB 500 Å (length 30 cm), Jordi DVB Mixed Bed (length 30 cm) column combination, temperature 30° C., THF/triethylamine as mobile phase, flow rate 0.4 ml/min, sample concentration 3 g/l, RI detector, evaluation against polystyrene standard. GPC measurements for determination of the polydispersity (M_{w}/Mₙ), weight-average molar mass (M_{w}) and number-average molar mass (Mₙ) of the end-capped polyether-modified amino-functional polybutadienes (K) may be conducted in the same manner.

### Determination of the Content of the 1,4-Cis, 1,4-Trans and 1,2 Units in the Polybutadiene:

The content of 1,4-cis, 1,4-trans and 1,2 units can be determined with the aid of ¹H-NMR spectroscopy. This method is familiar to the person skilled in the art.

### Determination of the Content of Epoxy Groups in the Epoxy-Functional Polybutadiene (C)(Epoxy Content, Degree of Epoxidation):

The content of epoxy groups was determined with the aid of ¹³C-NMR spectroscopy. A Bruker Avance 400 NMR spectrometer was used. The samples were for this purpose dissolved in deuterochloroform. The epoxy content is defined as the proportion of epoxidized butadiene units in mol % based on the entirety of all epoxidized and non-epoxidized butadiene units present in the sample. This corresponds to the number of epoxy groups in the epoxy-functional polybutadiene (C) divided by the number of double bonds in the polybutadiene (A) used.

### Determination of the Degree of Hydrogenation:

The determination of the degree of hydrogenation was carried out with the aid of 1H-NMR spectroscopy. A Bruker Avance 400 NMR spectrometer was used. The samples were for this purpose dissolved in deuterochloroform.

The double bond content of the polyether-modified polybutadiene (G) (i.e. prior to hydrogenation) was first determined, and also the double bond content of the hydrogenated polyether-modified polybutadiene (H) after hydrogenation. For this purpose, the integrals of the ¹H-NMR spectra between 4.8 and 6.3 ppm were determined before and after hydrogenation, which are proportional to the number of double bonds in the polybutadiene (“PB”) before (I_{PB,before}) and after (I_{PB,after}) hydrogenation. For the purpose of normalization, these integrals are based in this case in relation to the integrals of the 1H-NMR spectra between 2.8 and 4.2, which are proportional to the (unchanged) number of hydrogen atoms in the polyether backbone (“PE”), here also in each case before (I_{PE,before}) and after (I_{PE,after}) hydrogenation. The degree of hydrogenation is then determined according to the following equation:

$$Degree of hydrogenation = 1 - [ ( {I}_{PB , after} / {I}_{PE , after} ) / ( {I}_{PB , before} / {I}_{PE , before} ) ]$$

I_{PB,after}=Integral of the ¹H-NMR spectra between 4.8 and 6.3 ppm after hydrogenation
I_{PE,after}=Integral of the ¹H-NMR spectra between 2.8 and 4.2 ppm after hydrogenation
I_{PB,before}=Integral of the ¹H-NMR spectra between 4.8 and 6.3 ppm before hydrogenation
I_{PE,before}=Integral of the ¹H-NMR spectra between 2.8 and 4.2 ppm before hydrogenation

### Determination of the Acid Value:

The acid value was determined by a titration method in accordance with DIN EN ISO 2114.

### Synthesis Examples

### Step a), Preparation of Epoxidized Polybutadienes

### Example A1

An epoxidized polybutadiene was prepared using a polybutadiene of the formula (1) having the structure x=1%, y=24% and z=75% (Polyvest® 110). According to the prior art, a

5-L reactor under a nitrogen atmosphere was initially charged with 1500 g of Polyvest®110 and 146.3 g of conc. formic acid in 1500 g of chloroform at room temperature. Subsequently, 540 g of 30% H₂O₂ solution (30% by weight H₂O₂ based on the total mass of the aqueous solution) was slowly added dropwise and then the solution was heated to 50° C. for 7 hours. After the reaction had ended, the mixture was cooled to room temperature, the organic phase was removed and washed four times with dist, H₂O. Excess chloroform and residual water were distilled off. 1481 g of the product were obtained, which was admixed with 1000 ppm of Irganox® 1135 and stored under nitrogen. Evaluation by means of ¹³C-NMR gave a degree of epoxidation of ca. 15.8% of the double bonds. GPC evaluation gave: M_{w}=4690 g/mol; Mₙ=1982 g/mol; M_{w}/Mₙ=2.4

### Step b), Preparation of Amino-Functional Polybutadienes

### Example B1

An amino-functional polybutadiene having a degree of amination of ca. 15.8% was prepared using the epoxidized polybutadiene prepared in Example A₁. The degree of amination here is the number of amino groups of the amino-functional polybutadiene divided by the number of double bonds in the polybutadiene used in step a). For the preparation, 800 g of the epoxidized polybutadiene with 136.3 g of ethanolamine and 6.8 g of lithium bromide were initially charged in a 1 litre four-necked flask under a nitrogen atmosphere and the mixture heated at 180° C. with stirring. The mixture was stirred at this temperature for 15 hours. The viscosity increased during the reaction. After the reaction was complete, volatile components were removed by distillation at 180° C. and 20 mbar. The product was cooled to 60° C. 908 g of a yellowish product were obtained and stored under nitrogen. Evaluation by means of ¹³C-NMR showed complete conversion of all epoxy groups, which gives a degree of amination of ca. 15.8%.

### Step c), Alkoxylation of the Hydroxy- and Amino-Functional Polybutadienes

### Example C1 (Stoichiometry: 5 EO/5 PO Per Reactive NH/OH Group)

A 1.5 litre autoclave was initially charged under nitrogen with 197 g of the aminated polybutadiene prepared in Example B1 and heated to 115° C. with stirring. The reactor was evacuated down to an internal pressure of 30 mbar in order to remove any volatile ingredients present by distillation. 27.4 g of propylene oxide were fed in at 115° C. over 5 minutes. The reactor internal pressure rose to a maximum value of 2.3 bar (absolute) and decreased continuously during the course of the reaction. After 4 hours, the pressure stabilized at 0.7 bar (absolute). Volatile components were removed at 115° C. and 20 mbar, the reactor was depressurized to standard pressure with N₂ and the reaction mixture was cooled to 40° C. 17.6 g of 30% sodium methoxide solution (30% in methanol) were then added, the reactor contents inertized with nitrogen and heated to 115° C. with stirring. The reactor internal pressure fell here to 20 mbar and methanol was removed by distillation. A mixture of 382 g of propylene oxide and 310 g of ethylene oxide was added at 115° C. with stirring and cooling over 6 h at a maximum internal pressure of 3.2 bar. During the post-reaction period of 2.5 h at 115° C., the internal pressure fell continuously until pressure stabilized at 0.4 bar (absolute). Volatile components such as residual propylene oxide and ethylene oxide were distilled off under reduced pressure. The product was cooled to 80° C., neutralized with 30% phosphoric acid to an acid number of 0.1 mg KOH/g, admixed with 500 ppm of Irganox® 1135 and discharged through a filter. 881 g of a viscous, orange-coloured, clear polyether-modified amino-functional polybutadiene were discharged and stored under nitrogen. GPC evaluation gave: M_{w}=32 145 g/mol; Mₙ=8349 g/mol; M_{w}/Mₙ=3.85

### Example C2 (Stoichiometry: 3.8 PO Per Reactive NH/OH Group)

A 1.5 litre autoclave was initially charged under nitrogen with 181 g of the aminated polybutadiene prepared in Example B1 and heated to 115° C. with stirring. The reactor was evacuated down to an internal pressure of 30 mbar in order to remove any volatile ingredients present by distillation. 25.2 g of propylene oxide were fed in at 115° C. over 5 minutes. The reactor internal pressure rose to a maximum value of 2.4 bar (absolute) and decreased continuously during the course of the reaction. After 4.5 hours, the pressure stabilized at 0.7 bar (absolute). Volatile components were removed at 115° C. and 20 mbar, the reactor was depressurized to standard pressure with Na and the reaction mixture was cooled to 40° C. 32.2 g of 30% sodium methoxide solution (30% in methanol) were then added, the reactor contents inertized with nitrogen and heated to 115° C. with stirring. The reactor internal pressure fell here to 20 mbar and methanol was removed by distillation. 260 g of propylene oxide were added at 115° C. with stirring and cooling over 1.5 h at a maximum internal pressure of 2.9 bar. During the post-reaction period of 2 h at 115° C., the internal pressure fell continuously until pressure stabilized at 0.3 bar (absolute). Volatile components such as residual propylene oxide were distilled off under reduced pressure. The product was cooled to below 80° C., neutralized with 17.9 g lactic acid (90% in water) to an acid number of 0.1 mg KOH/g, and admixed with 1000 ppm of Irganox® 1135 and discharged. 421 g of a viscous, orange-coloured, slightly cloudy polyether-modified amino-functional polybutadiene were discharged and stored under nitrogen. GPC evaluation gave: M_{w}=25 386 g/mol; Mₙ=5226 g/mol; M_{w}/Mₙ=4.86

### Example C3 (Stoichiometry: 3.8 EO Per Reactive NH/OH Group)

A 1.5 litre autoclave was initially charged under nitrogen with 151 g of the hydroxy- and amino-functional polybutadiene prepared in Example B1 and heated to 115° C. with stirring. The reactor was evacuated down to an internal pressure of 30 mbar in order to remove any volatile ingredients present by distillation. 15.9 g of ethylene oxide were fed in at 115° C. over 5 minutes. The reactor internal pressure rose to a maximum value of 3.4 bar (absolute) and decreased continuously during the course of the reaction. After 5.5 hours, the pressure stabilized at 0.6 bar (absolute). Volatile components were removed at 115° C. and 20 mbar, the reactor was depressurized to standard pressure with N₂ and the reaction mixture was cooled to 40° C. 26.9 g of 30% sodium methoxide solution (30% in methanol) were then added, the reactor contents inertized with nitrogen and heated to 115° C. with stirring. The reactor internal pressure fell here to 20 mbar and methanol was removed by distillation. 164.7 g of ethylene oxide were added at 115° C. with stirring and cooling over 1.5 h at a maximum internal pressure of 3.4 bar. During the post-reaction period of 3 h at 115° C., the internal pressure fell continuously until pressure stabilized at 0.5 bar (absolute). Volatile components such as residual ethylene oxide were distilled off under reduced pressure. The product was cooled to below 80° C., neutralized with 14.9 g of lactic acid (90% in water) to an acid number of 0.1 mg KOH/g, and admixed with 1000 ppm of Irganox® 1135 and discharged. 317 g of a viscous, orange-red coloured, slightly cloudy polyether-modified amino-functional polybutadiene were discharged and stored under nitrogen. GPC evaluation gave: M_{w}=19 484 g/mol; Mₙ=4474 g/mol; M_{w}/Mₙ=3.45.

### Step d), Hydrogenation of the Polyether-Modified Amino-Functional Polybutadienes

### Example D1

A 500 ml four-necked flask was initially charged with 50 g of the alkoxylated, hydroxylated amino-functional polybutadiene prepared in Example C1 and 150 g of xylene. 0.25 g of Rh-100 (Wilkinson's catalyst) was then added. After heating to 120° C., 0.025-0.05 lpm (lpm=litres per minute) of hydrogen is introduced under a strong stream of argon and with stirring for 34 hours. Then. 0.25 g of Rh-100 was again added and 0.025-0.05 lpm of hydrogen was introduced for a further 10 hours. The product is hot-filtered after addition of 1.5 g of Harbolite 800 filter aid (Alpha Aesar GmbH & Co. KG). After distillation under reduced pressure, a brown-black cloudy product is obtained which is viscous when cold. The degree of hydrogenation is 64.6%. GPC evaluation gave: M_{w}=29 189 g/mol: Mₙ=8156 g/mol; M_{w}/Mₙ=3.58

### Example D2

A 250 ml four-necked flask was initially charged with 71 g of the alkoxylated, hydroxylated amino-functional polybutadiene with 3.55 g of Raney nickel (aluminium/nickel 50/50) and 0.71 g of palladium catalyst Pd-cat/C (5% Pd on activated carbon, 50% water content) under argon. After heating to 120° C., 0.025-0.05 lpm (lpm=litres per minute) of hydrogen is introduced under a strong stream of argon and with stirring for 86 hours. The product is diluted with 28.4 g of butyl acetate and hot-filtered after addition of 2.1 g of Harbolite 800 filter aid. After distillation under reduced pressure, a brown-black cloudy product is obtained which is viscous when cold. The degree of hydrogenation is 67.1%. GPC evaluation gave: M_{w}=32 447 g/mol; Mₙ=7294 g/mol; M_{w}/Mₙ=4.45

### Example D3

A 250 ml four-necked flask was initially charged with 50 g of the alkoxylated, hydroxylated amino-functional polybutadiene prepared in Example C2 and 50 g of butyl acetate under argon. Then, 0.5 g of palladium catalyst Pd-cat/C (5% Pd on activated carbon, 50% water content) were added. After heating to 120° C., 0.025-0.05 lpm (lpm=litres per minute) of hydrogen is introduced under a strong stream of argon and with stirring for 40 hours. The product is diluted again with 20 g of xylene and hot-filtered after addition of 1.5 g of Harbolite 800 filter aid. After distillation under reduced pressure, a brown-black product is obtained which is viscous when cold. The degree of hydrogenation is 49.6%. GPC evaluation gave: M_{w}=25 649 g/mol; Mₙ=7038 g/mol; M_{w}/Mₙ=3.64

### Example D4

A 250 ml four-necked flask was initially charged with 31.4 g of the alkoxylated, hydroxylated amino-functional polybutadiene prepared in Example C3 and 31.4 g of butyl acetate under argon. Then, 0.016 g of citric acid, 0.31 g of water. 1.57 g of Raney nickel (aluminium/nickel 50/50) and 0.31 g of palladium catalyst Pd-cat/C (5% Pd on activated carbon, 50% water content) were added. After heating to 120° C., 0.025-0.05 lpm (lpm=litres per minute) of hydrogen is introduced under a strong stream of argon and with stirring for 35 hours. The product is diluted again with 12.5 g of xylene and hot-filtered after addition of 1 g of Harbolite 800 filter aid. After distillation under reduced pressure, a brown-black cloudy product is obtained which is solid when cold. The degree of hydrogenation is 48.1%. GPC evaluation gave: M_{w}=17 776 g/mol; Mₙ=4925 g/mol; M_{w}/Mₙ=3.61

### Example D5

A 250 ml four-necked flask was initially charged with 31.8 g of the alkoxylated, hydroxylated amino-functional polybutadiene prepared in Example C3 with 1.59 g of Raney nickel (aluminium/nickel 50/50) and 0.32 g of palladium catalyst Pd-cat/C (5% Pd on activated carbon, 50% water content) under argon. After heating to 120° C., 0.025-0.05 lpm (lpmn=litres per minute) of hydrogen is introduced under a strong stream of argon and with stirring for 37 hours. The product is diluted with 30 g of xylene and hot-filtered after addition of 1 g of Harbolite 800 filler aid. After distillation under reduced pressure, a brown-black product is obtained which is viscous when cold. The degree of hydrogenation is 59.2%. GPC evaluation gave: M_{w}=18 536 g/mol; Mₙ=4821 g/mol; M_{w}/Mₙ=3.84

### Example D6

A 500 ml four-necked flask was initially charged with 50 g of the alkoxylated, hydroxylated amino-functional polybutadiene WD 1011 prepared in Example C1 and 150 g of xylene under argon. 1.5 g of Rh-100 were then added. After heating to 120° C., 0.025-0.05 lpm (lpm=litres per minute) of hydrogen is introduced under a strong stream of argon and with stirring for 20 hours. The product is hot-filtered after addition of 1.5 g of Harbolite 800 filter aid. After distillation under reduced pressure, a brown-black cloudy product is obtained which is solid when cold. The degree of hydrogenation is 97.9%. GPC evaluation gave: M_{w}=32 451 g/mol; Mₙ=9190 g/mol; M_{w}/Mₙ=3.53

### Example D7

A 500 ml four-necked flask was initially charged with 50 g of the alkoxylated, hydroxylated amino-functional polybutadiene WD 995 prepared in Example C3 and 150 g of butyl acetate under argon. 1.5 g of Rh-100 were then added. After heating to 120° C., 0.025-0.05 lpm (lpm=litres per minute) of hydrogen is introduced under a strong stream of argon and with stirring for 20 hours. The product is hot-filtered after addition of 1.5 g of Harbolite 800 filter aid. After distillation under reduced pressure, a brown-black product is obtained which is viscous when cold. The degree of hydrogenation is 47.0%. GPC evaluation gave: M_{w}=24 962 g/mol; Mₙ=6463 g/mol; M_{w}/Mₙ=3.86

1. A process for preparing one or more hydrogenated polyether-modified amino-functional polybutadienes, comprising:
a) reacting at least one polybutadiene (A) with at least one epoxidizing reagent (B) to give at least one epoxy-functional polybutadiene (C);
b) reacting the at least one epoxy-functional polybutadiene (C) with at least one amino-functional compound (D) to give at least one hydroxy- and amino-functional polybutadiene (E);
c) reacting the at least one hydroxy- and amino-functional polybutadiene (E) with at least one epoxy-functional compound (F) to give at least one polyether-modified amino-functional poly butadiene (G); and
d) hydrogenating the at least one polyether-modified amino-functional polybutadiene (G) to give at least one hydrogenated polyether-modified amino-functional polybutadiene (H).

2. The process according to claim 1, further comprising at least one of the following:
cc) reacting at least one polyether-modified amino-functional polybutadiene (G) without end-capped polyether radicals with at least one end-capping reagent (I) to give at least one polyether-modified amino-functional polybutadiene (G) comprising end-capped polyether radicals;
dd) reacting the at least one hydrogenated amino-functional polyether-modified polybutadiene (H) with at least one end-capping reagent (I) to give at least one hydrogenated polyether-modified amino-functional polybutadiene (H) comprising end-capped polyether radicals;
and/or at least one of the following:
e) colour lightening of the at least one hydrogenated polyether-modified amino-functional poly butadiene (H);
f) converting at least some amino groups of the at least one hydrogenated polyether-modified amino-functional polybutadiene (H) to quaternary ammonium groups with an acid and/or a quaternizing reagent.

3. The process according to claim 1, wherein from >0% to <100%, of the double bonds of the at least one polybutadiene (A) are epoxidized.

4. The process according to claim 1, wherein the at least one epoxidizing reagent (B) contains performic acid.

5. The process according to claim 1, wherein the at least one amino-functional compound (D) is selected from the group consisting of compounds having at least one primary and/or at least one secondary amino group.

6. The process according to claim 1, wherein the at least one epoxy-functional compound used in c) is selected
a. from the group consisting of alkylene oxides,
and/or
b. from the group consisting of glycidyl compounds.

7. The process according to claim 1, wherein in process d), at least 30% of the double bonds of the at least one polyether-modified polybutadiene (G) are hydrogenated.

8. The process according to claim 1, wherein d) is carried out with hydrogen in the presence of at least one hydrogenation catalyst.

9. A hydrogenated polyether-modified amino-functional polybutadiene (H), obtainable by a process according to claim 1.

10. The hydrogenated polyether-modified amino-functional polybutadiene (H) according to claim 9, which comprises units selected
both from the group consisting of divalent radicals (S), (T) and (U): 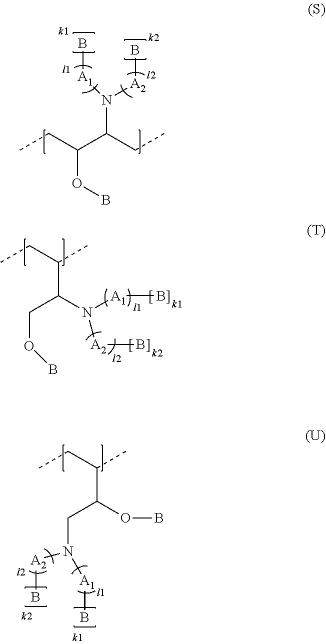
and from the group consisting of divalent radicals (V) and (W): 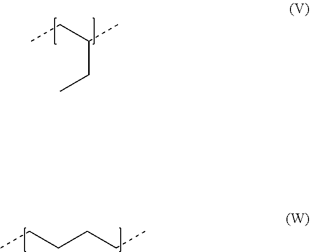
and optionally from the group consisting of divalent radicals (X), (Y) and (Z): 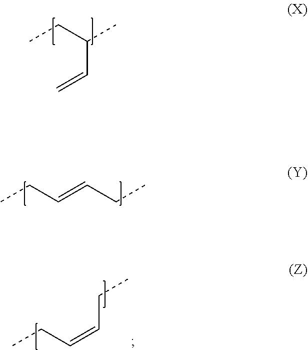
where
A₁ and A₂ are each independently organic radics, where the radicals A₁ and A₂ may be covalently bonded to each other,
B is each independently a radical of the formula (4a), 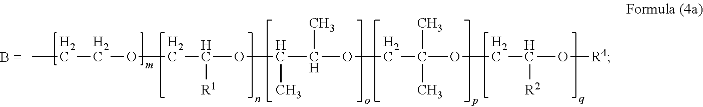
R¹ is each independently a monovalent hydrocarbon radical having 1 to 16 carbon atoms;
R² is a radical of the formula —CH₂—O—R³;
R³ is each independently a monovalent hydrocarbon radical having 3 to 18 carbon atoms;
R⁴ is each independently a monovalent organic radical having 1 to 18 carbon atoms or hydrogen;
and
k1 and k2 are each independently integers from 0 to 8;
l1 and l2 are integers and are each independently either 0 or 1;
m, n, o, p, and q are each independently rational numbers from 0 to 300 with the proviso that the sum total of m, n, o, p and q is greater than 1;
and each permutation of the units in the B radical, the number of which is specified by the indices m, n, o, p, and q, is included.

11. The hydrogenated polyether-modified amino-functional polybutadiene (H) according to claim 9, wherein a sum total of all units (S), (T) and (U) divided by a sum total of all units (S), (T), (U), (V), (W), (X), (Y) and (Z) is from >0% to 70.

12. The hydrogenated polyether-modified amino-functional polybutadiene (H) according to claim 9 wherein a number-average molar mass (Mₙ) of the polybutadiene moiety is from 200 g/mol to 20 000 g/mol.

13. The hydrogenated polyether-modified amino-functional polybutadiene (H) according to claim 9, wherein an average molar mass of the B radical is from 30 g/mol to 20,000 g/mol.

14. The hydrogenated polyether-modified amino-functional polybutadiene (H) according to claim 9, wherein a number-average molar mass (Mₙ) of the hydrogenated polyether-modified amino-functional polybutadiene (H) is from 1000 g/mol to 50 000 g/mol.

15. The process according to claim 3, wherein 4% to 20% of the double bonds of the at least one polybutadiene (A) are epoxidized.

16. The process according to claim 4, wherein the performic acid is formed in situ from formic acid and hydrogen peroxide.

17. The process according to claim 5, wherein the at least one amino-functional compound (D) is selected from the group consisting of butylamine, isobutylamine, hexylamine, octylamine, 2-ethylhexylamine, decylamine, laurylamine, ethanolamine, isopropanolamine, diethanolamine, diisopropanolamine, N-methylethanolamine, N-methylisopropanolamine, 2-amino-2-methyl-1-propanol, 2-amino-2-ethyl-1,3-propanediol, tris(hydroxymethyl)aminomethane (TRIS, 2-amino-2-(hydroxymethyl)propane-1,3-diol), morpholine, piperidine, cyclohexylamine, N,N-dimethylaminopropylamine (DMAPA), and benzylamine.

18. The process according to claim 6, wherein the at least one epoxy-functional compound used in c) is selected
a. from the group consisting of ethylene oxide, propylene oxide, 1-butylene oxide, cis-2-butylene oxide, trans-2-butylene oxide, isobutylene oxide, and styrene oxide, and/or
b. from the group consisting of phenyl glycidyl ether, o-cresyl glycidyl ether, tert-butylphenyl glycidyl ether, allyl glycidyl ether, butyl glycidyl ether, 2-ethylhexyl glycidyl ether, C₁₂/C14 fatty alcohol glycidyl ether, and C₁₃/C₁₅ fatty alcohol glycidyl ether.

19. The process according to claim 7, wherein at least 95% of the double bonds of the at least one polyether-modified poly butadiene (G) are hydrogenated.

20. The process according to claim 8, wherein d) is carried out with hydrogen in the presence of at least one hydrogenation catalyst selected from the group consisting of Raney nickel, palladium on activated carbon, and Wilkinson's catalyst.
